(19) United States
(12) Patent Application Publication
(10) Pub. No.: US 2007/0002898 A1
(43) Pub. Date: Jan. 4, 2007

(54) Flexible bandwidth communication system and method using a common physical layer technology platform

(75) Inventors: Adrian Boariu, Irving, TX (US); Prabodh Varshney, Coppell, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/452,505

(22) Filed: Jun. 13, 2006

Related U.S. Application Data
(60) Provisional application No. 60/690,099, filed on Jun. 13, 2005.

(51) Int. Cl. H04J 3/22

(52) U.S. Cl. 370/468; 370/329

(57) ABSTRACT

A method includes selecting one of a plurality of transmitter systems used to transmit data. Each transmitter system corresponds to one of a plurality of subbands. Each subband has a bandwidth and at least two of the subbands have different bandwidths. A physical layer technology is common to and used by each transmitter system to transmit on a respective subband. The selected transmitter system transmits the data. An apparatus includes a plurality of transmitter systems, each corresponding to one of a plurality of subbands. Each subband has a bandwidth and at least two of the subbands have different bandwidths. A physical layer technology is common to and used by each transmitter system to transmit on a respective subband. A controller is operable to select one of the transmitter systems to use to transmit data, and is operable to cause the selected transmitter system to transmit the data.

### CROSS-REFERENCE TO RELATED APPLICATIONS

The present application claims the benefit under 35 U.S.C. §119(e) of U.S. Provisional Application 60/690,099, filed on Jun. 13, 2005, incorporated herein by reference in its entirety.

### TECHNICAL FIELD

Embodiments of the invention pertain generally to multi-user communication systems, more particularly embodiments of the invention pertain to flexible bandwidth allocation.

### BACKGROUND

The following abbreviations are herewith defined:
AN access node
AT access terminal
CDMA code division multiplex access
FDMA frequency division multiple access
MAC medium access control
MC multicarrier
MC-CDMA multi-carrier CDMA
OFDM orthogonal frequency division multiplexing
OFDMA orthogonal frequency division multiple access
TDMA time division multiple access

Communication systems are used to transmit data associated with multiple different types of services. The communication is no longer merely associated with a single service with a uniform bandwidth requirement, which is invariant in time. The different types of services have different bandwidth requirements, which may also vary in short time intervals. One particular such type of service is packet data communication. Especially, a downlink channel for a given user may be used to transmit packets in bursts of varying length. It is important to be able to allocate to the user stations only the capacity needed. The transmission resource allocation to individual users must be indicated via a common channel. The transmission resource allocation information becomes more complicated and must be indicated frequently to the users due to the varying bandwidth requirement. This leads to increased consumption of common channel capacity.

The concept of a transmission resource is illustrated by way of an example in Orthogonal Frequency Division Multiplexing (OFDM). OFDM may be used, for example, in a fixed medium or in radio or microwave transmission. The OFDM is used, for example, in the HiperLAN2 and IEEE 802.11a Wireless Local Area Network (WLAN) standards. In the OFDM there is a carrier bandwidth, which is used to transmit data between a transmitter and a receiver. On the carrier bandwidth data is transmitted using a set of low bandwidth sub-carriers, which are mutually orthogonal. The orthogonality is achieved so that the sub-carrier frequencies are integer multiples of the inverse of symbol period time. In the OFDM the time domain is divided into symbol periods. The sub-carriers may be received using Fast Fourier Transform (FFT) even though the spectra of the sub-carriers overlap in the frequency domain.

When multiple users are sharing the resources used in a system applying OFDM modulation, the alternatives indicated above are possible. One may separate different users by TDMA, so that different OFDM symbols (or sequences of OFDM symbols) are allocated to different users. One may use spreading codes in the time domain, operating over multiple OFDM symbols, and these spreading codes may be allocated to different users using CDMA. Generalizing FDMA to OFDM modulation, individual sub-carriers may be allocated to different users, so that users are separated in frequency, implying Orthogonal Frequency Division Multiple Access (OFDMA). A minimum size transmission resource, which may be allocated to a given user, is a symbol, in other words, one sub-carrier during one OFDM symbol time. In practice a transmission resource may comprise a number of symbols, extending over multiple sub-carriers, multiple symbol times, or both. Also code division in the frequency domain is possible. In this method, spreading codes operate in the frequency domain as opposed to the time domain in normal CDMA. Users may be allocated different spreading codes. This is known as Multi-Carrier CDMA (MC-CDMA).

There are a variety of wireless communication systems today. An access terminal (AT) may be implemented to operate using a single system using a single physical layer technology, and we call such terminal a unimode AT. If the AT is capable of communicating with different communication systems, each communication system using a different physical layer technology, we call such terminal a multimode AT. Currently, an AT can take advantage of different spectrum bandwidth allocation in three ways.

First, a multimode AT can switch from a communication system using a first physical layer technology that has a first bandwidth allocation to a different communication system using a second physical layer technology operating in a different bandwidth if the user deems appropriate.

Second, if the multimode AT has the capability of receiving simultaneously from different communication systems each employing different physical layer technology, the AT can enable additional operating modes as desired.

Note that both processes of switching mode (the first way above) and enabling modes (the second way above) are user driven, and they imply operating with very different communication systems. This is implementation challenging and costly. Plus, switching from one communication system to another implies actually disconnecting from a system and connecting to another, which produces significant disruption in data reception. FIG. 1 shows a multimode AT operation with different AN systems employing different physical layer technology. FIG. 1 presents the operation of a multimode AT. For illustration purpose we consider CDMA 2000 as one physical layer technology and a WiFi system as another physical layer technology. The bandwidth of CDMA 2000 is 1.25 MHz, and several subbands are represented. The WiFi system operates in 5 MHz bandwidth. At it is shown there is no exchange of information between the two systems, and there is a medium access control (MAC) layer for each subband. The MACs for the CDMA 2000 are based on one physical layer technology, while the MAC for the WiFi system is based on another physical layer technology. In other words, each MAC for the CDMA 2000 is based on CDMA for 1.25 MHz subbands, while WiFi is based on, e.g., for IEEE 802.11g uses OFDM, complementary code keying (CCK) modulation and, as an option for faster link rates, packet binary convolutional coding (PBCC) modulation. Depending on capabilities of the AT, there can be a single connection at a time (AT is connected either to a CDMA subband or to WiFi band) or there can be a connection with both systems (CDMA 2000 and WiFi) simultaneously.

The third option is using a flexible multicarrier (MC) system, which allocates additional bandwidth based on, for example, capability of the AT, buffer status, etc. Note that traditional MC systems have a fixed carrier separation, i.e. the bandwidth of the subbands is fixed. Note that this mode of operation is most likely access node (AN) driven, i.e. the AN can request the AT to enable the reception of additional subbands. The system is indeed flexible and enabling/disabling a subband does not create a data disruption because the subbands are under the control of the same AN. However, because each subband is by itself a system, the AT has to monitor all allocated subbands simultaneously.

FIG. 2 shows a multimode AT operating with a MC AN system. The AT1 monitors three subbands simultaneously, while the AT2 monitors two subbands. The MC system has a Super-MAC controller/layer that has the task of assigning multiple subbands to an AT, as well as splitting/routing AT's traffic to corresponding MACs appropriately. Each subband is a CDMA 2000 subband (e.g., a 1.25 MHz subband) by itself.

As discussed above, flexible bandwidth allocation for the current communications systems involves significant increase in complexity for the AT.

### BRIEF SUMMARY

In an exemplary embodiment of the invention, a method is disclosed that includes selecting one of a plurality of transmitter systems to use to transmit data. Each transmitter system corresponds to one of a plurality of subbands. Each subband has a bandwidth and at least two of the subbands have different bandwidths. A physical layer technology is common to and used by each transmitter system to transmit on a respective subband. The method also includes transmitting the data using selected transmitter system.

In another exemplary embodiment of the invention, an apparatus is disclosed that includes a plurality of transmitter systems, each transmitter system corresponding to one of a plurality of subbands. Each subband has a bandwidth and at least two of the subbands have different bandwidths. A physical layer technology is common to and used by each transmitter system to transmit on a respective subband. The apparatus also includes a controller coupled to the transmitter systems and operable to select one of the transmitter systems to use to transmit data. The controller is further operable to cause the selected transmitter system to transmit the data.

In another exemplary embodiment, an apparatus includes a plurality of filters, each filter configured to filter information from a selected one of a plurality of subbands. At least two of the subbands have different bandwidths. Each filter has a bandwidth corresponding to a bandwidth of the selected subband. Each filter is configured to filter from the selected subband information received in the selected subband over a communication link. The apparatus also includes a detector selectively coupled to one of the filters. The detector uses a physical layer technology common to each of the plurality of subbands and is configured to determine received data from information in any one of the subbands. The apparatus also includes a controller operable to select one of the filters for coupling to the detector and to the communication link.

In another exemplary embodiment, a system is disclosed having a plurality of transmitter systems. Each transmitter system corresponds to one of a plurality of subbands, where each subband has a bandwidth. At least two of the subbands have different bandwidths. A physical layer technology is common to and used by each transmitter system to transmit on a respective subband. A controller is coupled to the transmitter systems and is operable to select one of the transmitter systems to use to transmit data. The controller is further operable to cause the selected transmitter system to transmit the data using a communication link. The system includes a plurality of filters. Each filter is configured to filter information from a selected one of the subbands. Each filter has a bandwidth corresponding to a bandwidth of the selected subband, and each filter is configured to filter from the selected subband information received in the selected subband over the communication link. The system also includes a detector selectively coupled to one of the filters. The detector uses a physical layer technology common to each of the plurality of subbands and configured to determine received data from information in any one of the subbands. The system further includes a controller operable to select one of the filters for coupling to the detector.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is illustrative of multimode AT operation with different AN systems subbands simultaneously.

FIG. 2 is a diagram illustrative of a multimode AT operating with a MC AN system.

FIG. 3 is a diagram illustrative of a flexible bandwidth system based on a common technology platform.

FIG. 4 is a schematic illustrative of a flexible bandwidth communication system in accordance with an embodiment of the invention.

FIG. 5 is a diagram illustrative of flexible spectrum deployment coverage.

FIG. 6 shows four 1.25 MHz bandwidths systems, a 5 MHz system and a 15 MHz system with their corresponding medium access control (MAC) controllers/layers.

FIG. 7 is a flowchart a simplified procedure of inter-subband handover that has been detailed above for the example considered herein.

FIG. 8 is a diagram of a simplified implementation of transmitter and receiver in accordance with an embodiment of the invention.

FIG. 9 is a flowchart of an exemplary method performed in a system of the disclosed invention.

FIG. 10 is a block diagram of an exemplary transmitter or receiver in accordance with an exemplary embodiment of the disclosed invention.

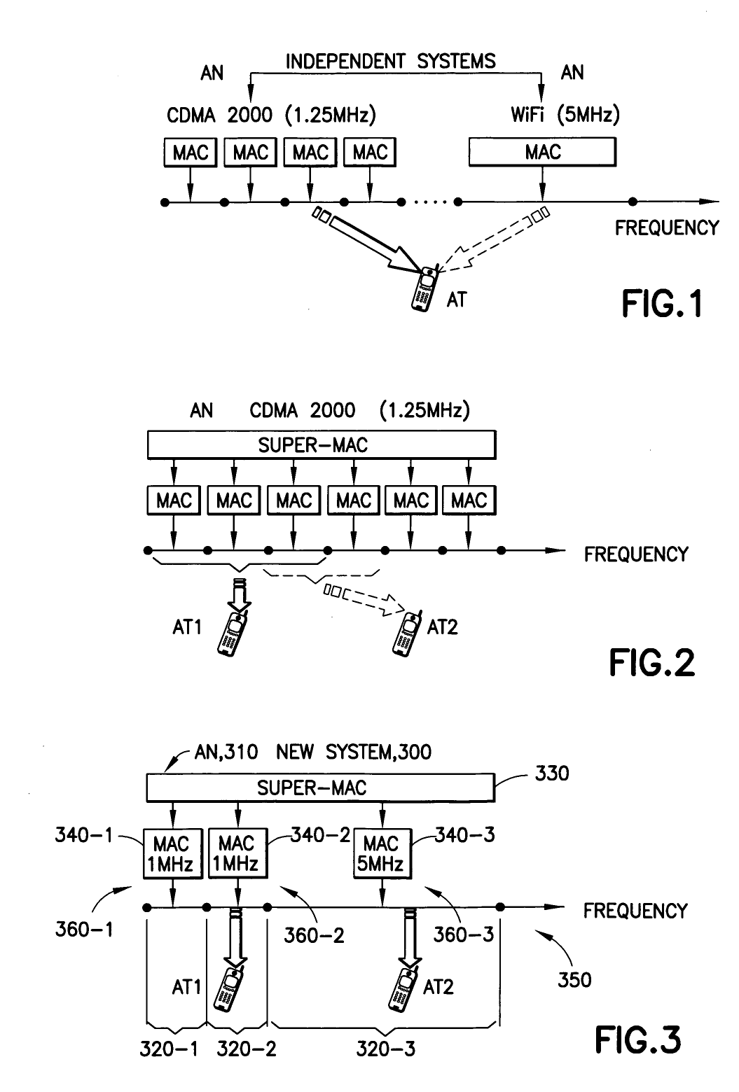

### DETAILED DESCRIPTION OF EXEMPLARY EMBODIMENTS

In the following description of the exemplary embodiment, reference is made to the accompanying drawings which form a part hereof, and in which is shown by way of illustration of embodiments in which the invention may be practiced. It is to be understood that other embodiments may be utilized, as structural and operational changes may be made without departing from the scope of the invention.

To overcome limitations in the prior art, and to overcome other limitations, a system and method disclosed herein allow a flexible bandwidth system, where the spectrum is divided in subbands having different bandwidths. Each subband can be considered a system by itself. Although the subbands can have different bandwidths, the subbands actually have implemented the same system from physical layer technology point of view in order to allow the AT to be less complex. Some system parameters can differ from a subband to another. For example, if the system is based on orthogonal frequency division multiplexing (OFDM) forward links, certain system design parameters—e.g. cyclic prefix length, modulation order used in the subband, packet sizes—may be different. Unlike MC system, the AT operates in a single subband at a time instant. Like in MC system there is a Super-MAC controller/layer that has a task of simply routing (e.g., no splitting) the data for a particular AT, as well as requesting a given AT to switch the operation subband when certain criteria are meet; e.g. better/worse radio link quality, high/low traffic load in a given subband, etc. Thus, the proposed system has the flexibility of a MC system without incurring its implementation burden. The system proposed in this invention is variable bandwidth based on a common physical layer technology platform with MAC controller/layer selection.

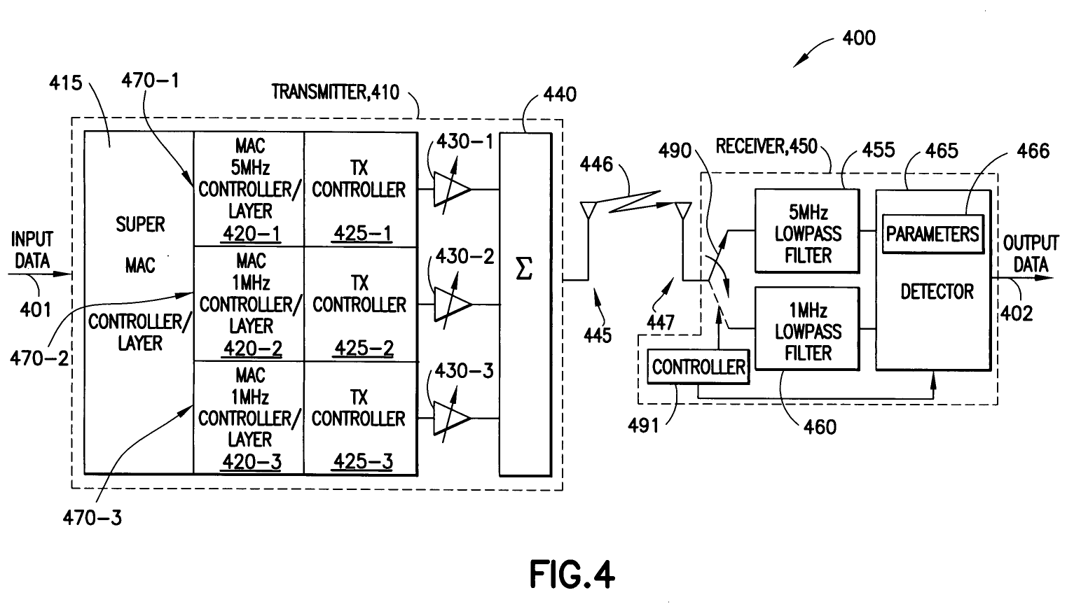

FIG. 3 shows an example of how the proposed system can be implemented. In the example the system 300 (e.g., AN 310, comprising the Super MAC controller/layer 330 and the MAC controllers/layers 340, each MAC controller/layer 340 being part of a transmission system 360 communicating with AT1 and AT2) uses three subbands 320-1 through 320-3 with two different bandwidths of 1 MHz and 5 MHz. In this example, the spectrum 350 is divided into the subbands 320 and each subband corresponds to a transmission system 360 (i.e., see transmission systems 470 in FIG. 4). An AT operates within a single subband; AT1 is in the second subband 320-2 of 1 MHz bandwidth, while AT2 is in the third subband 320-3 of 5MHz bandwidth. Once an AT operates in a given subband, the Super-MAC controller/layer 330 simply routes the data from above layers to the MAC controller/layer 340-1 through 340-3 that controls the corresponding subband 320.

The Super-MAC controller/layer 330 can also request an AT to change the subband if certain criteria are fulfilled, like a change in radio link condition, buffer status, etc. For example, if the AT1 radio link condition improves significantly, than Super-MAC 330 can signal AT1 to switch to 5 MHz subband 320-3, which offers higher data rates and lower delays. Note that all subbands 320 use the same technology platform and therefore the same physical layer technology for the physical layer (e.g., in MAC controller/layer 340). This allows the system 300 to reuse the most of the hardware (providing, e.g., low cost and complexity) while achieving high flexibility with respect to spectrum allocation and data rates that can be delivered. For example, a CDMA system can be used as a common physical layer technology in 1 MHz and in 5 MHz subbands; of course the chip rate in 5 MHz subband is five times greater than in 1 MHz subband.

FIG. 4 shows a simplified implementation of an exemplary embodiment of the proposed invention. Only the blocks that are addressed in the present invention are depicted for simplicity. FIG. 4 shows a communication system 400 comprising a transmitter 410 (e.g., AN 310 of FIG. 3) and receiver 450 (e.g., residing in AT1 or AT2 of FIG. 3). In the view of the discussion presented in Section 3, the blocks incorporated into transmitter 410 should be straightforward. The transmitter 410 includes a “super” (e.g., supervisor) MAC controller/layer 415, three transmission systems 470-1 through 470-3, an adder 440, and an antenna 445. The three transmission systems 470 include MAC controllers/layers 420-1 through 420-3 (corresponding to MAC controllers/layers 340-3 through 340-1, respectively), transmitter (TX) controllers 425-1 through 425-3, three transmission portions 430-1 through 430-3 (each containing, e.g., modulators, frequency oscillators, power amplifiers, etc., as is known in the art). Three transmission systems 470-1 through 470-3 are shown. Each transmission system 470 corresponds to one subband 320 (see FIG. 3) and includes one of the MAC controllers/layers 420, a corresponding transmitter controller 425, and a corresponding transmission portion 430. The transmitter 410 and receiver 450 communicate using link 446 using one of the subbands 320. The transmitter (e.g., super MAC controller/layer 415) routes input data 401 to a selected transmission system 470 for transmission over the link 446 to the receiver 450.

Regarding the receiver 450, it is noticeable that there are incorporated lowpass filters 455, 460 for each bandwidth available at transmitter 410 in order to allow the receiver to operate in subbands 320 that have different bandwidths. In this example, there is a 5 MHz lowpass filter 455 and a 1 MHz lowpass filter 460, each of which can receive information from a subband 320 over the link 446 using antenna 447 and through the switch 490. For instance, the 1 MHz lowpass filter 460 can receive information from a selected one of subbands 620-1 or 620-2, corresponding to transmission systems 470-2 and 870-3, respectively. A controller 491, which controls receiver 450, controls the switch 491. The detector 465 should be configurable to work with different system parameters specific to the operating bandwidth. This should not be a significant problem because the physical layer technology is common to each of and every subband 320 regardless of the bandwidth of the subband 320. In order to allow the detector 465 to be configurable to work with different system parameters specific to the operating bandwidth as defined by a subband 320, parameters 466 are provided, as shown in Table 1 below. Not shown in FIG. 4 is a tuneable local oscillator that is used in the receiver 450 to select, as is known in the art, a bandwidth corresponding to the subband 320. The detector 465 produces output data 402 from information on the selected subband 320.

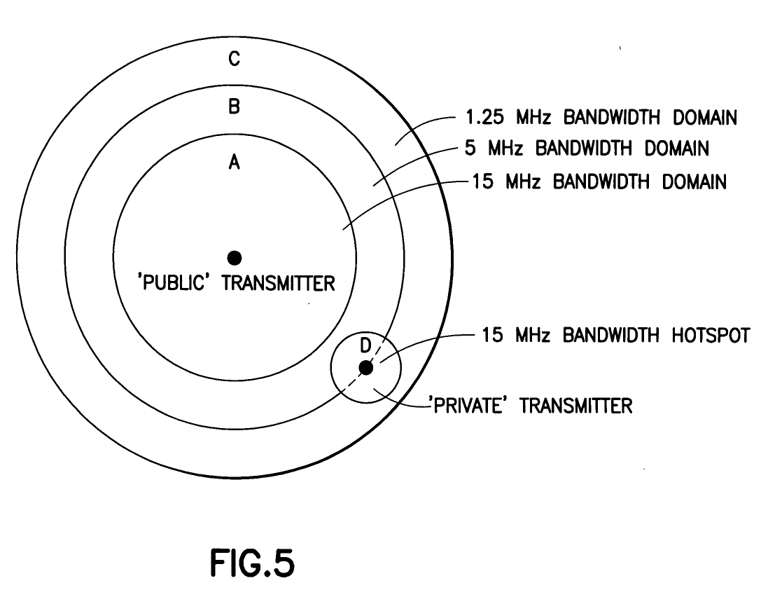

FIG. 5 is a diagram illustrative of flexible spectrum deployment coverage. For the example, it is assumed that the operator has available a 25 MHz spectrum bandwidth, which is labeled in FIG. 5 as public transmitter. The operator may choose, for example, to divide its spectrum in four subbands of 1.25 MHz, one subband of 5 MHz and one subband of 15 MHz. Because it is well-known that the larger the bandwidth the smaller the coverage area for a given transmit power, the operator by dividing the spectrum as mentioned above, chooses actually to create concentric regions that support significant different data rates. As FIG. 5 suggestively shows, the cell has three “zones”—“A”, “B” and “C”—where a mobile can experience significant different data rates, with the effect that the closer is to the transmitter, the higher the data rate a mobile can experience. It is important to note that the coverage of 1.25 MHz bandwidth system goes from transmitter to the edge of the cell (the 1.25 MHz subband system covers all the zones, i.e. A+B+C). However, the invention allows the transmitter to handover a mobile to a subband that is more adequate, for example, to its data rate request and/or channel strength condition.

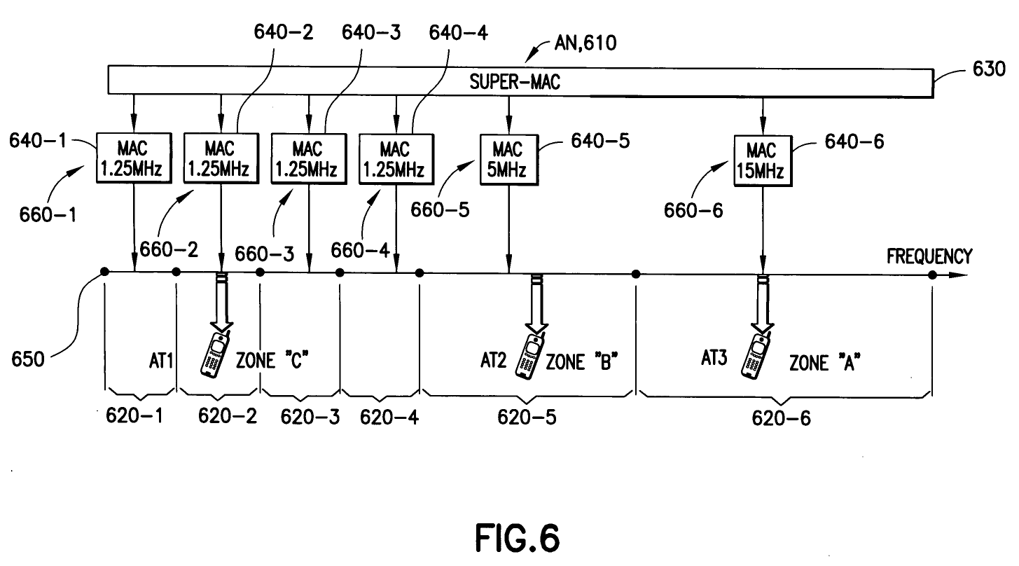

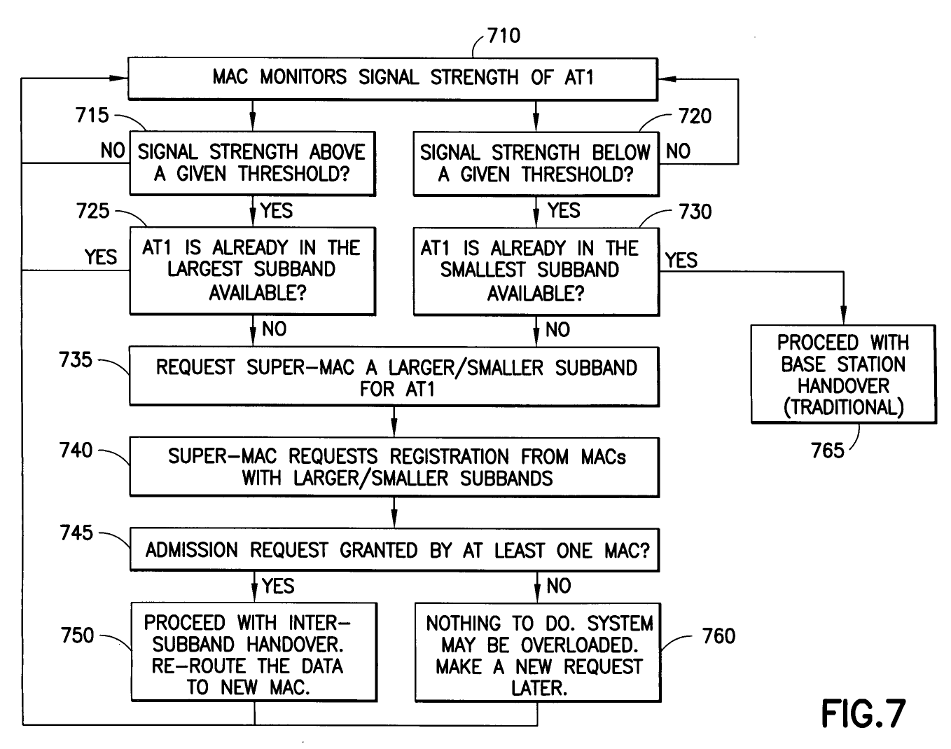

A more detailed description of how the transmitter may be implemented in order to accommodate the example presented in FIG. 5 is provided in FIG. 6. Refer now to FIGS. 6 and 7. A simplified procedure of inter-subband handover is presented in FIG. 7 as a flowchart. FIG. 6 shows an AN 610 that implements four 1.25 MHz bandwidth transmission systems 660-1 through 660-4, a 5 MHz transmission system 660-5, and a 15 MHz transmission system 660-6 with their corresponding medium access control (MAC) controllers/layers 640-1 through 640-6. Also shown are subbands 620-1 through 620-6, each of which has bandwidths from spectrum 650 as associated with corresponding MAC controllers/layers 660. As an important aspect of our invention, all transmission systems 660 are based on the same physical layer technology, regardless of the bandwidth of the transmission system 660. This is very important in order to allow a simple implementation of the receiver.

FIG. 6 also shows the Super-MAC controller/layer 630 that acts as a coordinator for the MAC controllers/layers 640 of each of the subbands 620. For example, consider the mobile AT1, which is in a 1.25 MHz subband (zone “C” according to FIG. 5) and moves toward the transmitter (e.g., the public transmitter in FIG. 5, including the AN 610 of FIG. 6). The MAC controller/layer 640-2 monitors (e.g., through pilot symbols and other known techniques) the signal strength reported by AT1 (block 710). When the signal strength is above a given threshold (block 715), the MAC controller/layer 640-2 reports to Super-MAC controller/layer 630 that AT1 has experienced improved signal strength. If the AT1 is not already in the largest subband available in terms of bandwidth (not area as shown in FIG. 5) (block 725), the Super-MAC controller/layer 630 requests a larger subband 620 from one of the MAC controllers/layers 640 (block 735). The Super-MAC controller/layer 630 now requests (block 740) from, e.g., MAC-5 MHz controller/layer 640-5 an update about, for example, its load and availability to support an additional terminal (block 740). If MAC-5 MHz controller/layer 640-5 acknowledges the request of supporting an additional user and thereby grants the request for the user (block 745), Super-MAC controller/layer 630 coordinates the inter-subband (e.g., inter-frequency) handover of AT1 from the 1.25 MHz subband 620-2 and MAC controller/layer 640-2 to the 5 MHz subband 620-5 and MAC controller/layer 640-5. This handover includes all procedures necessary for a typical handover process (block 750). When the handover has been completed successfully, the Super-MAC controller/layer 630 routes incoming data in a data stream for AT1 to, obviously, MAC-5 MHz controller/layer 640-5. Now AT1 operates in the 5 MHz subband 620-5, which has more data rates capabilities than the lower bandwidth 1.25 MHz subband system 660-2.

It is important to note in the above example that MAC-5 MHz controller/layer 640-5 may refuse the registration of the AT1 in the subband 620-5 if the load is too heavy (block 760), in which case the system 660-5 may be overloaded. In this situation, AT1 would still operate into 1.25 MHz subband 620-2 although AT1 is getting closer to the transmitter. A similar procedure can be performed if the signal strength of a mobile (e.g., AT1) starts degrading. For instance, if a signal strength is below a given threshold (block 720), it is determined if the AT1 is in the smallest subband in terms of bandwidth available (block 730). If not, the Super-MAC controller/layer 630 can request a smaller subband 620 from the MAC controllers/layers 640 (block 735). Of course, if there is no lower bandwidth system 660, the handover must be performed in the traditional way to another transmitter, i.e. to another cell (block 765).

As presented above, all physical layers that are controlled by MAC controller/layers in FIG. 6 should be design based on a common technology, in order to take advantage of a simple and efficient implementation of the system. An example is presented in the Table 1, which has exemplary parameters for the physical layer technology of the OFDM system. In this particular example we choose to change the OFDM symbol duration inversely proportional with the subband bandwidth size, e.g. the subbands 10 MHz and 1.25 MHz have the ratio of 10/1.25=8 and the symbol durations ratio for them is 416.66/52.83=8.

TABLE 1
Example of common physical layer design parameters based on OFDM
technology

| Subband | Cyclic prefix | OFDM symbol | Tone bandwidth |
|---|---|---|---|
| bandwidth (MHz) | duration (μsec) | duration (μsec) | (kHz) |
| 1.25 | 21.16 | 416.66 | 2.528 |
| 5 | 5.29 | 104.16 | 10.114 |
| 10 | 2.64 | 52.083 | 20.227 |
| 15 | 1.76 | 37.72 | 30.341 |

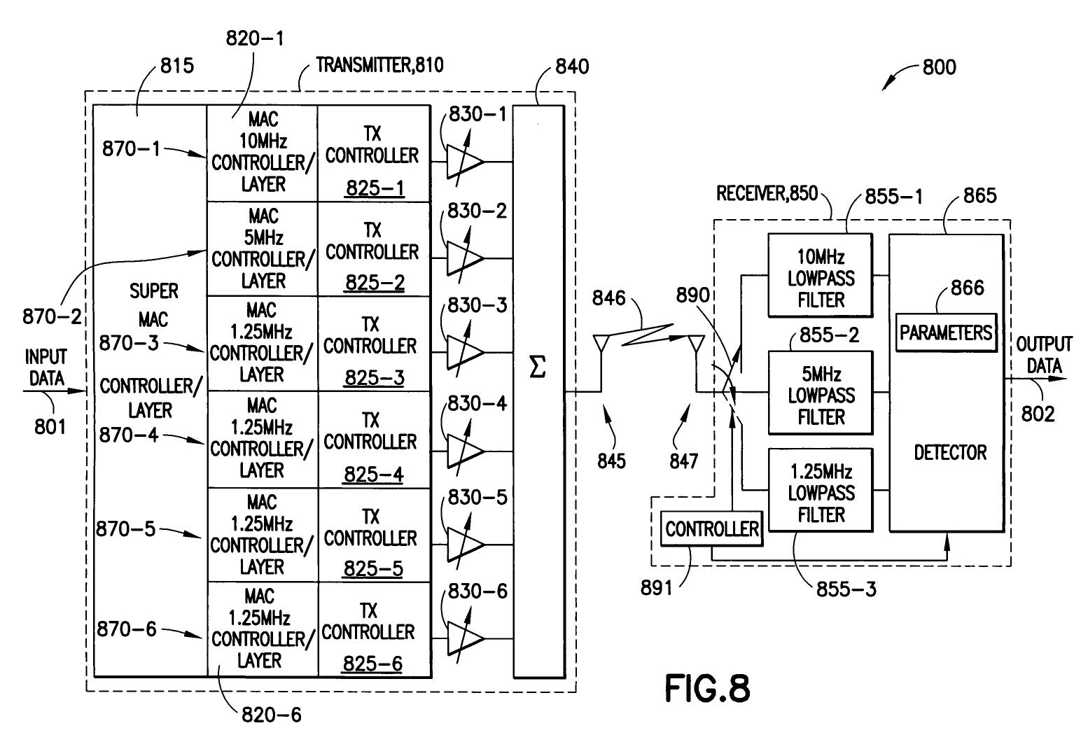

This design uniformity for all physical layers ensures that the proposed flexible bandwidth system is highly modularized, therefore it is easier to be implemented while maintaining its flexibility. A simplified implementation block diagram is presented in FIG. 8 and is similar to the block diagram shown in FIG. 3. FIG. 8 corresponds to FIG. 6. FIG. 8 shows a communication system 800 comprising a transmitter 810 (e.g., AN 610 of FIG. 6) and receiver 850 (e.g., residing in AT1, AT2, or AT3 of FIG. 6). The transmitter 810 includes a “super” (e.g., supervisor) MAC controller/layer 815, six transmission systems 870-1 through 870-6 (corresponding to transmission systems 660-6 through 660-1, respectively, of FIG. 6), an adder 840, and an antenna 845. The six transmission systems 870 include MAC controllers/layers 820-1 through 820-6 (corresponding to MAC controllers/layers 640-6 through 640-1, respectively, of FIG. 6), transmitter (TX) controllers 825-1 through 825-6, three transmission portions 830-1 through 830-6 (each containing, e.g., modulators, frequency oscillators, power amplifiers, etc., as is known in the art). Six transmission systems 870-1 through 870-6 are shown. Each transmission system 870 corresponds to one subband (e.g., subbands 620 of FIG. 6) and includes one of the MAC controllers/layers 820, a corresponding transmitter controller 825, and a corresponding transmission portions 830. The transmitter 810 and receiver 850 communicate using link 846 using one of the subbands 620. The transmitter 810 routes input data 801 to a selected transmission system 870 for transmission over the link 846 to the receiver 850.

Regarding the receiver 850, it is noticeable that there are incorporated lowpass filters 855-1 through 850-3 for each bandwidth available at transmitter 810 in order to allow the receiver 850 to operate in subbands 620 that have different bandwidths. In the example of FIG. 8, there is a 10 MHz lowpass filter 855-1, a 5 MHz lowpass filter 855-2, and a 1 MHz lowpass filter 855-3, each of which can receive information from a subband 620 over the link 846 using antenna 847 and through the switch 890. For instance, the 1.25 MHz lowpass filter 855-3 can receive information from a selected one of subbands 620-3 through 620-6, corresponding to transmission systems 870-3 through 870-6, respectively. A controller 891, which controls receiver 850, controls the switch 891. Note that the receiver is very simple. Except for the lowpass filters 850 that should match the available transmitter bandwidths (e.g., as implemented using subbands 620) and that can be switched according to the operating bandwidth, the detector 850 can be easily implemented because all subbands 620 use the same physical layer technology, which for the particular example considered herein is OFDM. Problems related to synchronization, channel estimation, detection, etc., can be implemented similarly for all subbands 620. In order to allow the detector 865 to be configurable to work with different system parameters specific to the operating bandwidth, parameters 866 are provided, as shown in Table 1 above. Not shown in FIG. 8 is a tuneable local oscillator that is used in the receiver 850 to select, as is known in the art, a bandwidth corresponding to the subband 620. The detector 865 produces output data 802 based on information in the selected subband 620.

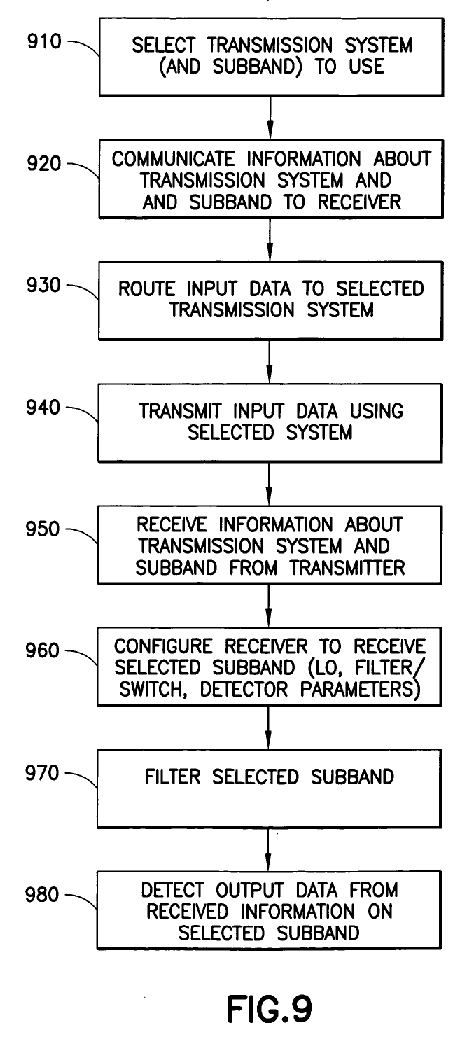

FIG. 9 shows a flowchart of an exemplary method performed in a system of the disclosed invention. Blocks 910 through 940 are performed by a transmitter (e.g., transmitter 410, 810) and blocks 950-980 are performed by a receiver (e.g., receiver 450, 850). In block 910, a transmission system and corresponding subband are selected for use. Such selection is performed, e.g., using the method shown in FIG. 7 and by using the Super-MAC controller/layer and the individual MAC controllers/layers as described in reference to FIG. 7. In block 920, information about the transmission system and the corresponding subband are communicated to the receiver, e.g., as described in reference to block 750 of FIG. 7. In block 930, the input data is routed to the selected transmission system, e.g., by the super MAC controller/layer 815. The input data is transmitted using the selected transmission system in block 940. It is noted that in an exemplary embodiment, the super MAC controller/layer 815 and/or the selected MAC controller/layer 820 causes the input data to be transmitted.

In block 950, the receiver receives information about the transmission system and corresponding subband from the transmitter. The receiver (e.g., the controller 491, 891 of the receiver 410, 810) configures the receiver 410, 810 to receive the selected subband (block 960). Such configuration is performed, e.g., by tuning a local oscillator (LO) to a particular frequency, selecting the appropriate filter (e.g., filters 455, 460, 855-1 through 855-3), typically by using switch 490, 890, and setting the detector parameters (e.g., parameters 466, 866). In block 970, the selected subband is filtered using the selected filter. In block 980, the output data (e.g., output data 402, 802) is detected by the detector from received information on the selected subband, where the detector 465, 865 uses a physical layer technology common to all subbands 320, 620 and can operate on received information from any one of the subbands 320, 620.

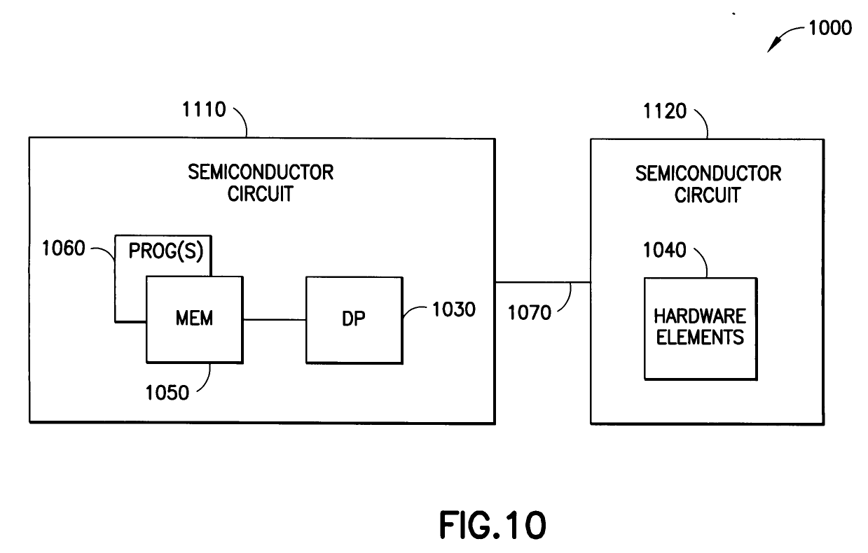

FIG. 10 is a block diagram of an exemplary transmitter or receiver in accordance with an exemplary embodiment of the disclosed invention. In the example of FIG. 10, the element 1000 is used as a transmitter or receiver. The element 1000 includes two semiconductor circuits 1110 and 1120 coupled through buses 1070. Semiconductor circuit 1110 comprises a data processor (DP) 1030 coupled to a memory 1050 having one or more programs (PROG(S)) 1060. The semiconductor circuit 1120 includes hardware elements 1040. For example, the Super MAC controller/layer 815 and MAC controllers/layers 820 might be implemented as programs 1060 and the hardware elements 1040 could include the TX controllers 825, the transmission portions 830, and the adder 840. As another example, the lowpass filters 855 and switch 890 could be implemented as hardware elements 1040, while the detector 865 and controller 891 implemented as programs 1060. Still other combinations are possible, such as implementing everything in a transmitter/receiver on one semiconductor circuit, implementing a portion of a TX controller 825 in programs 1060, or implementing a portion of the MAC controller/layer 820 on the hardware elements 1040. FIG. 10 is for exposition only.

Furthermore, n general, the various embodiments may be implemented in hardware or special purpose circuits, software, logic or any combination thereof. For example, some aspects may be implemented in hardware, while other aspects may be implemented in firmware or software which may be executed by a microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or other computing devices, or some combination thereof. In embodiments where a system may be implemented by a data processor 1030, a signal bearing medium (e.g., as part of memory 1050) may be used that tangibly embodies a program of machine-readable instructions executable by the data processor to perform operations described herein.

As described above, embodiments of the inventions may be practiced in various components such as integrated circuits. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. For instance, “MAC controller/layer” herein is typically a MAC layer that includes controller functionality. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method comprising:
selecting one of a plurality of transmitter systems to use to transmit data, where each transmitter system corresponds to one of a plurality of subbands, each subband has a bandwidth, at least two of the subbands have different bandwidths, and a physical layer technology is common to and used by each transmitter system to transmit on a respective subband; and
transmitting the data using the selected transmitter system.

2. The method of claim 1, wherein selecting further comprises selecting the transmitter system based at least in part on bandwidth of a corresponding subband and a signal strength received from a receiver to which data is transmitted.

3. An apparatus comprising:
a plurality of transmitter systems, each transmitter system corresponding to one of a plurality of subbands, where each subband has a bandwidth, at least two of the subbands have different bandwidths, and a physical layer technology is common to and used by each transmitter system to transmit on a respective subband; and
a controller coupled to the transmitter systems and operable to select one of the transmitter systems to use to transmit data, where the controller is further operable to cause the selected transmitter system to transmit the data.

4. The apparatus of claim 3, wherein each transmission system comprises a media access control (MAC) layer coupled to a transmitter controller, the transmitter controller further coupled to a transmission portion.

5. The apparatus of claim 4, wherein the controller comprises a supervisor MAC layer.

6. The apparatus of claim 3, further comprising an adder coupled to each of the transmission systems and at least one antenna coupled to the adder.

7. An apparatus comprising:
a plurality of filters, each filter configured to filter information from a selected one of a plurality of subbands, where at least two of the subbands have different bandwidths, each filter having a bandwidth corresponding to a bandwidth of the selected subband, each filter configured to filter from the selected subband information received in the selected subband over a communication link;
a detector selectively coupled to one of the filters, the detector using a physical layer technology common to each of the plurality of subbands and configured to determine received data from information in any one of the subbands; and
a controller operable to select one of the filters for coupling to the detector and to the communication link.

8. The apparatus of claim 7, further comprising a switch coupled to the filters and operable to select one of the filters to be coupled to the communication link, where the controller is coupled to the switch and operable to cause the switch to select the one filter for coupling to the communication link.

9. The apparatus of claim 7, wherein the controller is further configured to cause the detector to use a first set of parameters in response to a first filter having a first bandwidth being selected and to use a second set of parameters in response to a second filter having a second bandwidth being selected.

10. The apparatus of claim 8, further comprising at least one antenna coupled to an input of the switch, wherein each of the filters is coupled to an output of the switch.

11. A system comprising:
a plurality of transmitter systems, each transmitter system corresponding to one of a plurality of subbands, where each subband has a bandwidth, at least two of the subbands have different bandwidths, and a physical layer technology is common to and used by each transmitter system to transmit on a respective subband; and
a controller coupled to the transmitter systems and operable to select one of the transmitter systems to use to transmit data, where the controller is further operable to cause the selected transmitter system to transmit the data using a communication link;
a plurality of filters, each filter configured to filter information from a selected one of the subbands, each filter having a bandwidth corresponding to a bandwidth of the selected subband, each filter configured to filter from the selected subband information received in the selected subband over the communication link;
a detector selectively coupled to one of the filters, the detector using a physical layer technology common to each of the plurality of subbands and configured to determine received data from information in any one of the subbands; and
a controller operable to select one of the filters for coupling to the detector.

12. The system of claim 11, wherein each of at least two given subbands of the plurality of subbands has a given bandwidth and wherein a given filter of the plurality of filters has the given bandwidth, and wherein the controller is operable to select the given filter when one of the at least two given subbands is received on the communication link.
